(19) United States
(12) Patent Application Publication
(10) Pub. No.: US 2006/0144963 A1
(43) Pub. Date: Jul. 6, 2006

(54) Spray applicator for particulate material

(76) Inventors: Terrence M Fulkerson, Brunswick Hill, OH (US); Brian D Mather, North Olmsted, OH (US); Jeffrey R Shutic, Wakeman, OH (US); Michael Bordner, Green Springs, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/515,400

(22) PCT Filed: Aug. 18, 2004
(86) PCT No.: PCT/US04/26887

§ 371 Date: Apr. 29, 2005

Related U.S. Application Data
(60) Provisional application No. 60/481,250, filed on Aug. 18, 2003.
(60) Provisional application No. 60/523,012, filed on Nov. 18, 2003.
(60) Provisional application No. 60/554,655, filed on Mar. 19, 2004.

(51) Int. Cl. B05B 7/04

(52) U.S. Cl. 239/433; 239/690; 239/79

(57) ABSTRACT

A spray applicator for particulate material includes a unitary powder passageway sized to be particularly useful with dense phase material flow. An external electrode assembly is provided that is keyed to an air cap that is used to provide atomizing and pattern shaping air to the dense phase material that exits the powder passageway. In this manner a nozzle is not required. A manual and automatic version of the applicator are provided, including a pattern shaping trigger that can be used by the operator to dynamically adjust the spray pattern. An automatic gun version has the multiplier located at a mounting location to reduce bending moments of the elongated gun.

### RELATED APPLICATIONS

This application claims the benefit of pending U.S. provisional patent application Ser. Nos. 60/481,250 filed on Aug. 18, 2003, for POWDER APPLICATOR WITH PATTERN ADJUSTMENT; 60/523,012 filed on Nov. 18, 2003 for POWDER SPRAY APPLICATOR; and 60/554,655 filed on Mar. 19, 2004 for POWDER COATING MATERIAL SPRAY GUN, the entire disclosures all of which are fully incorporated herein by reference.

### TECHNICAL FIELD OF THE INVENTION

The invention relates generally to material application systems, for example but not limited to powder coating material application systems. More particularly, the invention relates to an applicator that reduces cleaning time, color change time and improves convenience of use.

### BACKGROUND OF THE INVENTION

Material application systems are used to apply one or more materials in one or more layers to an object. General examples are powder coating systems, other particulate material application systems such as may be used in the food processing industry, pharmaceuticals, electronics industry and product assembly, liquid spraying systems such as for applying conformal coatings to printed circuit boards or adhesives to surfaces, and liquid paint spraying systems. These are but a few examples of a wide and numerous variety of systems used to apply materials to an object.

The application of dry particulate material is especially challenging on a number of different levels. An example, but by no means a limitation on the use and application of the present invention, is the application of powder coating material to objects using a powder spray gun. Because sprayed powder tends to expand into a cloud or diffused spray pattern, known powder application systems use a spray booth for containment. Powder particles that do not adhere to the target object are generally referred to as powder overspray, and these particles tend to fall randomly within the booth and will alight on almost any exposed surface within the spray booth. Therefore, cleaning time and color change times are strongly related to the amount of surface area that is exposed to powder overspray.

In addition to surface areas exposed to powder overspray, color change times and cleaning are strongly related to the amount of interior surface area exposed to the flow of powder during an application process. Examples of such interior surface areas include all surface areas that form the powder flow path, from a supply of the powder all the way through the powder spray gun. Interior surface areas are typically cleaned by blowing purge air through the powder flow path. Moreover, wear items that have surfaces exposed to material impact, for example a spray nozzle in a typical powder spray gun, can be difficult to clean due to impact fusion of the powder on the wear surfaces. Still further, in known powder spray guns the spray pattern is changed primarily by changing the nozzle or changing the volume and/or flow rate of flow air that pushes the powder through the gun.

Many known material application systems utilize electrostatic charging of the particulate material to improve transfer efficiency. One form of electrostatic charging commonly used with powder coating material is corona charging that involves producing an ionized electric field through which the powder passes. The electrostatic field is produced by a high voltage source connected to a charging electrode that is installed in the electrostatic spray gun. Typically these electrodes are disposed directly within the powder path, adding to the complication of purging the powder path. Moreover, typical electrostatic spray guns have a heavy voltage multiplier located in the gun body near the outlet end of the gun, which can make the gun cumbersome and tiresome to manipulate.

### SUMMARY OF THE INVENTION

The invention provides apparatus and methods for improving the cleanability of a spray applicator for particulate material, such as, for example but not by way of limitation, powder coating materials. Cleanability refers to, among other things, reducing the quantity of powder overspray that needs to be removed from exterior surfaces of the applicator. Cleanability also can refer to reducing the quantity of powder that needs to be purged or otherwise removed from interior surfaces that define the powder path through the spray applicator. Improving cleanability results in faster color change times by reducing contamination risk and shortening the amount of time needed to remove a first color powder from the applicator prior to introducing a second color powder.

In accordance with one aspect of the invention, cleanability is improved by reducing the effective exterior surface areas of the spray applicator that are exposed to powder overspray. In accordance with another aspect of the invention, the exterior surfaces are contoured or profiled so as to allow the surface areas to more effectively shed powder overspray. In one embodiment, a spray applicator has a housing that is formed to have a narrow rounded upper portion with steeply sloped sides, as compared to a lower portion of the housing.

In accordance with another aspect of the invention, interior surface areas are reduced so as to reduce the amount of surface area exposed to the flow of material. In accordance with another aspect of the invention, wear surfaces and interior surface areas are reduced by providing a spray applicator that eliminates use of a nozzle device. In one embodiment, the material being applied by the applicator exits the applicator body directly from a feed tube that extends through a housing of the applicator.

In further accordance with this aspect of the invention, interior surface areas are reduced by designing the spray applicator to operate with high density low volume powder feed. In this context, high density means that the powder fed to the spray applicator has a substantially reduced amount of entrainment or flow air in the powder as compared to conventional powder flow systems. Low volume simply refers to the use of less volume of flow air needed to feed the powder due to its higher density as compared to conventional powder spray guns. By removing a substantial amount of the air in the powder flow, the associated conduits, such as a powder feed hose and a powder feed tube, can be substantially reduced in diameter, thereby substantially reducing the interior surface area. This also results in an significant reduction in the overall size of the spray applicator, thus further reducing the amount of exterior surface area exposed to powder overspray. For manually operated spray applicators, the invention provides an easily replaceable or removable powder path. In any case, a powder flow path is realized that optionally comprises only a single part.

In accordance with another aspect of the invention, a spray applicator is contemplated that operates with high density low volume powder feed. In one embodiment, a spray contamination risk and shortening the amount of time needed to remove a first color powder from the applicator prior to introducing a second color powder.

In accordance with one aspect of the invention, cleanability is improved by reducing the effective exterior surface areas of the spray applicator that are exposed to powder overspray. In accordance with another aspect of the invention, the exterior surfaces are contoured or profiled so as to allow the surface areas to more effectively shed powder overspray. In one embodiment, a spray applicator has a housing that is formed to have a narrow rounded upper portion with steeply sloped sides, as compared to a lower portion of the housing.

In accordance with another aspect of the invention, interior surface areas are reduced so as to reduce the amount of surface area exposed to the flow of material. In accordance with another aspect of the invention, wear surfaces and interior surface areas are reduced by providing a spray applicator that eliminates use of a nozzle device. In one embodiment, the material being applied by the applicator exits the applicator body directly from a feed tube that extends through a housing of the applicator.

In further accordance with this aspect of the invention, interior surface areas are reduced by designing the spray applicator to operate with high density low volume powder feed. In this context, high density means that the powder fed to the spray applicator has a substantially reduced amount of entrainment or flow air in the powder as compared to conventional powder flow systems. Low volume simply refers to the use of less volume of flow air needed to feed the powder due to its higher density as compared to conventional powder spray guns. By removing a substantial amount of the air in the powder flow, the associated conduits, such as a powder feed hose and a powder feed tube, can be substantially reduced in diameter, thereby substantially reducing the interior surface area. This also results in an significant reduction in the overall size of the spray applicator, thus further reducing the amount of exterior surface area exposed to powder overspray. For manually operated spray applicators, the invention provides an easily replaceable or removable powder path. In any case, a powder flow path is realized that optionally comprises only a single part.

In accordance with another aspect of the invention, a spray applicator is contemplated that operates with high density low volume powder feed. In one embodiment, a spray applicator is provided that includes an air cap positioned at an outlet end of the spray applicator. The air cap permits an air stream to be directed at a high density powder flow that exits a powder feed tube. This arrangement not only eliminates the use of a nozzle, but also adds diffusing or atomizing air into the high density powder stream that exits the feed tube. In an alternative embodiment, an optional exterior electrode is provided in association with the air cap to provide an electrostatic spray applicator. The electrode is disposed exterior the spray applicator housing and powder flow path. In alternative embodiments, the electrode is retained in an electrode holder that is molded about the electrode, and optionally the electrode holder is keyed to the air cap so that the electrode is always optimally positioned with respect to the outlet end of the powder feed tube.

In accordance with another aspect of the invention, use of the air cap allows for spray pattern control by adjusting the flow of air that impinges on the powder stream. In one embodiment, a switch is provided by which an operator can adjust the spray pattern by simple actuation of the switch. Software logic is provided to allow for easy adjustment of the spray pattern.

Other aspects of the invention include providing a spray applicator that is more user friendly by locating a heavy component such as a voltage multiplier in a rearward portion of the applicator housing. For an automatic gun, as contrasted to a manually held gun, the rearward multiplier is realized in one embodiment by the use of an elongated electrical cable that extends from the multiplier output to a resistor and electrode located in a forward portion of the spray applicator. This allows the applicator to be mounted at its heavier rearward end thereby reducing strain and vibration on the elongated applicator when it is installed on a reciprocator or gun mover. In another embodiment, heat sink features are provided to further facilitate use of high density powder flows.

These and other aspects and advantages of the present invention will be apparent to those skilled in the art from the following description of the preferred embodiments in view of the accompanying drawings.

### BRIEF DESCRIPTION OF THE DRAWINGS

FIG. 1 is a simplified schematic diagram of a powder coating material application system utilizing the present invention;

FIG. 2A is a spray applicator in accordance with the invention and illustrated in longitudinal cross-section;

FIG. 2B is an enlarged view of the forward circled portion of FIG. 2A and FIG. 2C is an enlarged view of the rearward circled portion of FIG. 2A;

FIGS. 3A and 3B illustrate the spray applicator of FIG. 2A in exploded perspective;

FIG. 4 is an air cap illustrated in front perspective;

FIG. 5 is a longitudinal section of the air cap of FIG. 4;

FIG. 6 is a longitudinal section of the air cap of FIG. 4 to illustrate an electrode retained therewith;

FIGS. 7A-C illustrate an electrode and holder assembly;

FIG. 8A illustrates a manual spray applicator in elevation in accordance with the invention;

FIG. 8B illustrates the applicator of FIG. 8A in longitudinal cross-section;

FIG. 8C is a perspective illustration of a powder tube used in the applicator of FIGS. 8A and 8B; and

FIG. 9 is a logic flow diagram for a pattern adjust algorithm in accordance with the invention.

### DETAILED DESCRIPTION OF THE INVENTION AND EXEMPLARY EMBODIMENTS THEREOF

The invention contemplates a number of new aspects for a spray applicator for particulate material. The spray applicator is especially useful in combination with a material application system that uses dense phase flow of the particulate material. By “dense phase” is meant that the air present in the particulate flow is about the same as the amount of air used to fluidize the material at the supply such as a feed hopper. As used herein, “dense phase” and “high density” are used to convey the same idea of a low air volume mode of material flow in a pneumatic conveying system where not all of the material particles are carried in suspension. In such a dense phase system, the material is forced along a flow passage by significantly less air volume, with the material flowing more in the nature of plugs that push each other along the passage, somewhat analogous to pushing the plugs as a piston through the passage. With smaller cross-sectional passages this movement can be effected under lower pressures.

In contrast, conventional flow systems tend to use a dilute phase which is a mode of material flow in a pneumatic conveying system where all the particles are carried in suspension. Conventional flow systems introduce a significant quantity of air into the flow stream in order to pump the material from a supply and push it through under positive pressure to the spray application devices. For example, most conventional powder coating spray systems utilize Venturi pumps to draw fluidized powder from a supply into the pump. A Venturi pump by design adds a significant amount of air to the powder stream. Typically, flow air and atomizing air are added to the powder to push the powder under positive pressure through a feed hose and an applicator device. Thus, in a conventional powder coating spray system, the powder is entrained in a high velocity high volume of air, thus necessitating large diameter powder passageways in order to attain usable powder flow rates.

Dense phase flow is oftentimes used in connection with the transfer of material to a closed vessel under high pressure. The present invention, in being directed to material application rather than simply transport or transfer of material, contemplates flow at substantially lower pressure and flow rates as compared to dense phase transfer under high pressure to a closed vessel.

As compared to conventional dilute phase systems having air volume flow rates of about 3 to about 6 cfm (such as with a Venturi pump arrangement, for example), the present invention may operate at about 0.8 to about 1.6 cfm, for example. Thus, in the present invention, powder delivery rates may be on the order of about 150 to about 300 grams per minute.

Dense phase versus dilute phase flow can also be thought of as rich versus lean concentration of material in the air stream, such that the ratio of material to air is much higher in a dense phase system. In other words, in a dense phase system the same amount of material per unit time is transiting a cross-section (of a tube for example) of lesser area as compared to a dilute phase flow. For example, in some embodiments of the present invention, the cross-sectional area of a powder feed tube is about one-fourth the area of a feed tube for a conventional Venturi type system. For comparable flow of material per unit time then, the material is about four times denser in the air stream as compared to conventional dilute phase systems.

The present invention is directed to a spray applicator and various improvements therein, some of which are specific to a low pressure dense phase applicator, but others of which will find application in many types of material flow systems, whether dense phase, low pressure dense phase, or other. Accordingly, the present invention is not specifically concerned with the manner in which a dense phase material flow is created and fed to the applicator. In general, dense phase delivery is performed by a pump that operates to pull material into a chamber under negative pressure and discharge the material under positive pressure with a low air volume as noted above. There are a number of known dense phase pump and transfer systems, including but not limited to the following disclosures: EP Application No. 03/014,661.7; PCT Publication 03/024,613 A1; and PCT Publication 03/024,612 A1; the entire disclosures of which are fully incorporated herein by reference.

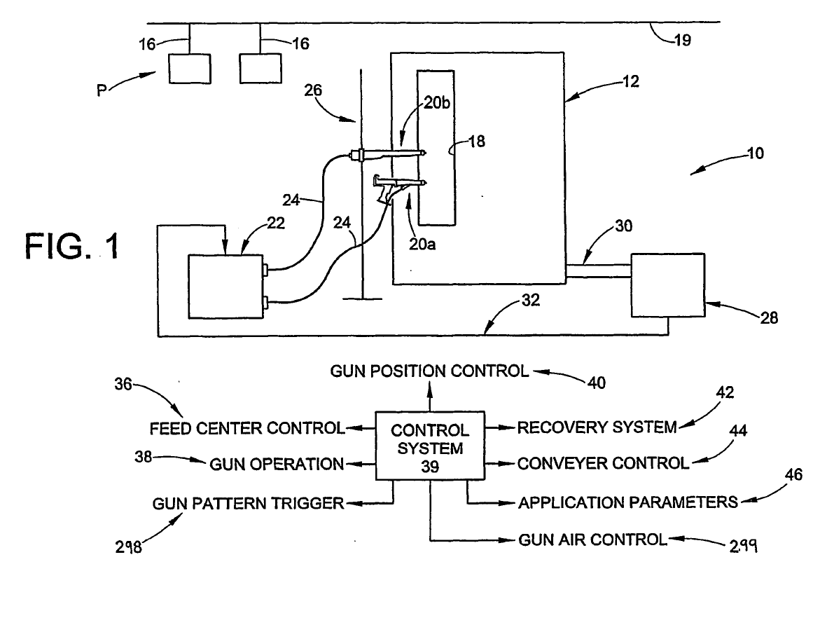

With reference to FIG. 1, in an exemplary embodiment, the present invention is illustrated being used with a material application system, such as, for example, a typical powder coating spray apparatus 10. Such an arrangement commonly includes a powder spray booth 12 in which an object or part P is to be sprayed with a powder coating material. The application of powder to the part P is generally referred to herein as a powder spray or application operation, however, there may be any number of control functions, steps and parameters that are controlled and executed before, during and after powder is actually applied to the part.

As is known, the part P is suspended from an overhead conveyor 14 using hangers 16 or any other conveniently suitable arrangements. The booth 12 includes one or more openings 18 through which one or more spray applicators 20 may be used to apply coating material to the part P as it travels through the booth 12. The applicators 20 may be of any number depending on the particular design of the overall system 10. Each applicator can be a manually operated device as in device 20a, or a system controlled device, referred to herein as an automatic applicator 20b, wherein the term “automatic” simply refers to the fact that an automatic applicator is mounted on a support and is triggered on and off by a control system, rather than being manually supported and manually triggered. The present invention is directed to manual and automatic spray applicators.

It is common in the powder coating material application industry to refer to the powder applicators as powder spray guns, and with respect to the exemplary embodiments herein we will use the terms applicator and gun interchangeably. However, it is intended that the invention is applicable to material application devices other than powder spray guns, and hence the more general term spray applicator is used to convey the idea that the invention can be used in many material application systems in addition to powder coating material application systems. Some aspects of the invention are likewise applicable to electrostatic spray guns as well as non-electrostatic spray guns.

The spray guns 20 receive powder from a feed center 22 or other supply through an associated powder feed or supply hose 24. The automatic guns 20b typically are mounted on a support 26. The support 26 may be a simple stationary structure, or may be a movable structure, such as an oscillator that can move the guns up and down during a spraying operation, or a gun mover or reciprocator that can move the guns in and out of the spray booth, or a combination thereof.

The spray booth 12 is designed to contain powder overspray within the booth, usually by a large flow of containment air into the booth. This air flow into the booth is usually effected by a powder reclamation or recovery system 28. The recovery system 28 pulls air entrained powder overspray from the booth, such as for example through a duct 30. In some systems the powder overspray is returned to the feed center 22 as represented by the return line 32. In other systems the powder overspray is either dumped or otherwise reclaimed in a separate receptacle.

Other than the spray applicators, the selected design and operation of the material application system 10, including the spray booth 12, the conveyor 14, the recovery system 28, and the feed center or supply 22, form no part of the present invention and may be selected based on the requirements of a particular coating application. It is preferred although not required that the supply 22 provide a dense phase powder flow to the spray applicators 20. A control system 34 likewise may be a conventional control system such as a programmable processor based system or other suitable control circuit. The control system 34 executes a wide variety of control functions and algorithms, typically through the use of programmable logic and program routines, which are generally indicated in FIG. 1 as including but not necessarily limited to feed center control 36 (for example supply controls and pump operation controls), gun operation control 38, gun position control 40 (such as for example control functions for the reciprocator/gun mover 26 when used), powder recovery system control 42 (for example, control functions for cyclone separators, after filter blowers and so on), conveyor control 44 and material application parameter controls 46 (such as for example, powder flow rates, applied film thickness, electrostatic or non-electrostatic application and so on). Conventional control system theory, design and programming may be utilized.

The control functions for gun operation 38 include but are not limited to gun trigger on and off times, electrostatic parameters such as voltage and current settings and monitoring, and powder flow rates to the guns. These control functions may be conventional as is well known. However, in addition, the present invention does contemplate a new control function for the spray applicators of the present invention, specifically related to spray pattern adjusting and powder atomization air, as will be set forth herein below. This additional gun control function is made available by the present invention in the use of an air assist feature along with the feature of no longer using a nozzle device, used for dense phase powder flow, as contrasted to conventional systems wherein nozzles are commonly used and dense phase powder flow is not used.

While the described embodiments herein are presented in the context of a spray applicator for a powder coating material application system, those skilled in the art will readily appreciate that the present invention may be used in many different dry particulate material application systems, including but not limited in any manner to: talc on tires, super-absorbents such as for diapers, food related material such as flour, sugar, salt and so on, desiccants, release agents, and pharmaceuticals. The specific design and operation of the material application system selected provides no limitation on the present invention except as otherwise expressly noted herein.

While various aspects of the invention are described and illustrated herein as embodied in combination in the exemplary embodiments, these various aspects may be realized in many alternative embodiments, either individually or in various combinations and sub-combinations thereof. Still further, various alternative embodiments as to the various aspects and features of the invention, such as alternative materials, structures, configurations, methods, devices, software, hardware, control logic and so on may be described herein, but such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are only intended to be critical values if so expressly stated.

Even from the general schematic illustration of FIG. 1 it can be appreciated that such complex systems can be very difficult and time consuming to clean and to provide for color change. Typical powder coating material is very fine and tends to be applied in a fine cloud or spray pattern directed at the objects being sprayed. Even with the use of electrostatic technology, a significant amount of powder overspray is inevitable. Cross contamination during color change is a significant issue in many industries, therefore it is important that the material application system be able to be thoroughly cleaned between color changes. Color changes however necessitate taking the material application system offline and thus is a cost driver. The present invention is directed to providing a spray applicator that is easier and faster to clean. Additional features and aspects of the invention are applicable separately from the concern for cleanability.

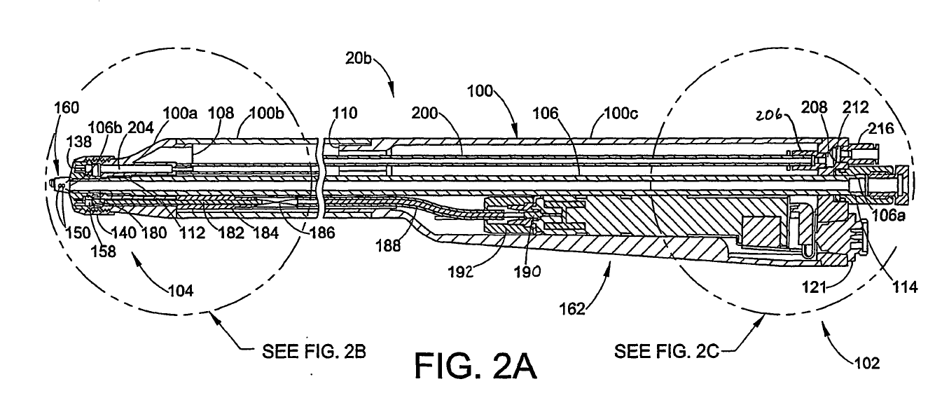

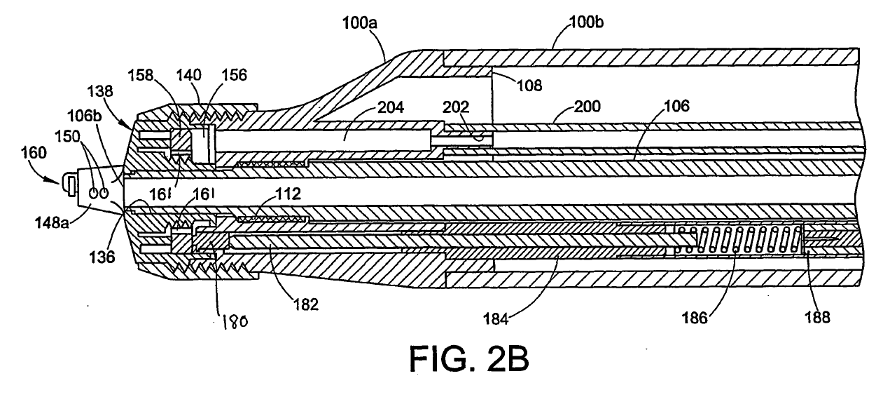

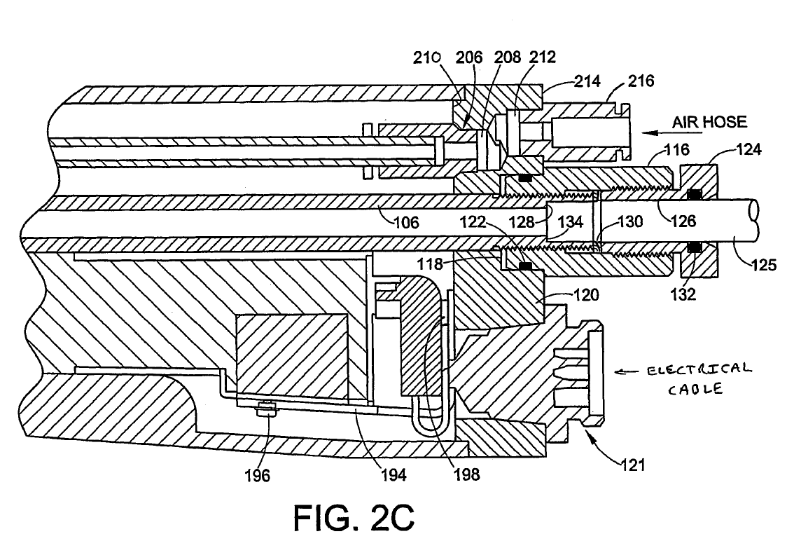

With reference to FIGS. 2A and 2B, an exemplary embodiment of an automatic spray applicator 20b in accordance with the invention is illustrated. The same embodiment is illustrated in exploded perspective in FIGS. 3A and 3B.

The spray applicator 20b includes a main housing 100 that encloses most of the applicator components. The housing 100 has a powder inlet end 102 and an outlet end 104. A powder tube 106 extends substantially through the housing 100. The powder tube 106 forms a straight and uninterrupted powder path from an inlet end 106a thereof to an outlet end 106b thereof. The powder tube is preferably a single piece of tubing to minimize joints that can trap powder. This makes the applicator 20b easy to clean and purge internally. The only joint in the powder path within the gun housing 100 is where a powder hose (not shown) is connected to the inlet end 102 of the gun as will be described herein below.

The housing 100 in this embodiment is a three section housing including a front section 100a, an elongated middle section 100b and a back section 100c. The front section 100a includes a boss 108 at its back end that fits inside the forward end of the middle section 100b with preferably a snug friction fit. The back section 100c includes a boss 110 at its forward end that fits inside the rearward end of the middle section 100b with preferably a snug friction fit. The powder tube 106 includes a forward threaded portion 112 that threadably mates with an internally threaded portion of the front section 100a. The powder tube 106 also includes a rearward threaded portion 114 (FIG. 2C) that threadably mates with a lock nut 116. The lock nut 116 partially extends into a counterbore 118 of a heat sink 120. The lock nut 116 abuts the counterbore during assembly of the gun. Once the powder tube 106 has been threadably joined to the front section 100a of the housing 100 and tightened down, the lock nut 116 is then tightened, which causes the powder tube 106 to be pulled backward in tension. This action pulls the three housing sections 100a, b and c axially together in compression such that the powder tube 106 acts like a tie rod to hold the housing sections tightly together. The lock nut 116 includes a seal 122, such as for example an o-ring, that provides a friction fit between the lock nut 116 and the heat sink 120.

A powder tube lock knob 124 is threadably joined to the lock nut 116. A forward end of a powder feed hose 125 is inserted through a bore 126 of the lock knob and bottoms against an inner shoulder 128 formed in the powder tube 106. A lock ring 130 is captured between a forward end of the lock knob 124 and the back edge of the powder tube 106. The lock ring allows easy insertion of a powder feed tube 125 into the inlet end of the gun 20b. The lock ring 130 however grips the outer wall of the feed tube and prevents the feed tube from backing out. The lock ring 130 tightly engages the feed tube 125 when the lock knob 124 is tightened down against the lock nut 116. The powder tube 125 can be easily removed for color change by simply loosening the lock knob 124. A seal 132 is provided to prevent loss of powder. The seal 132 also provides a friction fit so that when the powder tube 125 is removed from the gun, the lock knob 124 does not slide down the length of the powder tube.

It will thus be apparent from FIGS. 2A and 2C that the powder path through the spray applicator 20b is defined by the powder tube 116. The only joint is the location 134 where the powder feed hose 125 abuts the powder tube 116 shoulder 128. Other than that one joint, powder can flow along an uninterrupted path through the spray gun to the outlet end 104. Thus the gun is easy to purge for color change and has no significant entrapment areas in the powder path. For use with a dense phase particulate material, the powder tube diameter is substantially reduced as compared to a conventional powder spray gun powder tube. For example, in one embodiment of the invention, the inner diameter of the powder tube may be about six millimeters whereas in a conventional dilute phase system it may be on the order of 11 to 12 millimeters.

The powder tube 106 extends through the housing 100 and the front end 106b is received in a central bore 136 of an air cap 138 that is retained on the front section 100a by a threaded retaining nut 140. With the powder tube 106 extending all the way through the gun, there is no nozzle device as used in typical prior art powder spray guns. Rather, powder will exit the gun from the front end 106b of the powder tube.

At this point it is noted that the spray applicator 20b will typically be a rather long device, with most of the length of the applicator defined by the middle section 100b. The overall gun length may be several feet, for example, five feet.

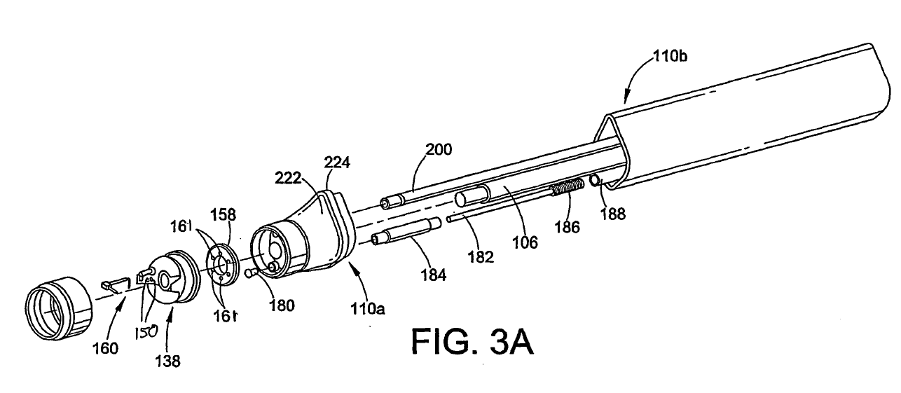

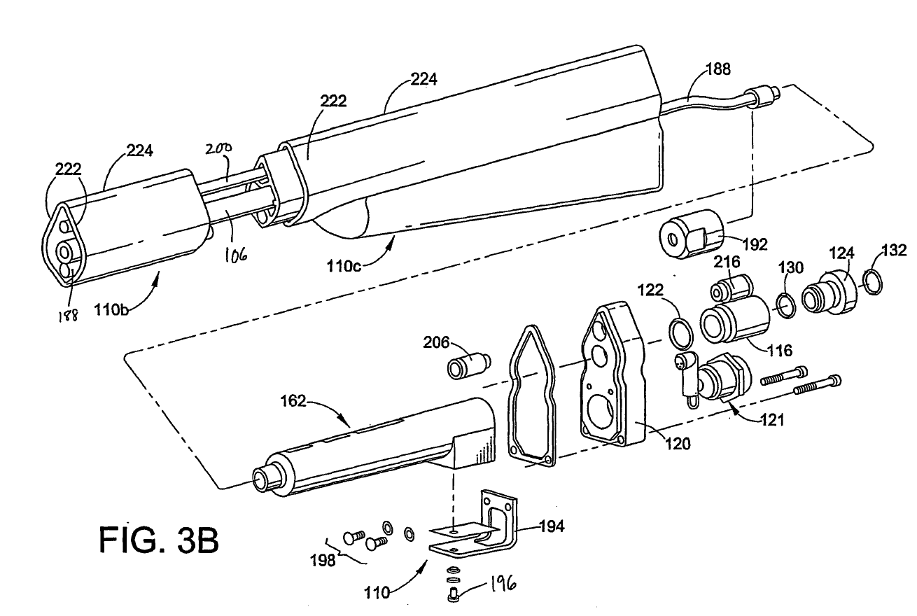

The air cap 138 is best illustrated in FIGS. 4 and 5. The air cap 138 is provided in accordance with one aspect of the invention to add air, primarily as atomizing or diffusion air, to the powder flow that exits the powder tube end 106b. The invention contemplates adding air to the powder flow for dense phase particulate systems. In the absence of air being added, the powder flow in a dense phase system is nearly fluid like with the powder flowing much like water in a tube.

The air cap 138 includes a central passage 136 that receives the front end of the powder tube 106. The passage 136 is sized so as to loosely receive the powder tube end. This helps to center the powder stream for proper presentation of the powder stream to the air jets 150. This also allows air to pass around the outside of the tube end to prevent powder from migrating back inside the gun housing. The central passage 136 is defined by a male threaded inner tubular portion 142. The male threads 144 receive a conductive diffuser ring as will be described herein shortly. An outer wall 146 of the air cap is also male threaded as at 148 and mates with the threaded retainer nut 140. The retainer nut 140 is thus threadably joined to the air cap 138 and a threaded end of the front housing section 100a (FIG. 2B) to securely hold the air cap on the housing.

As best illustrated in FIG. 5, the air cap includes two air jet prongs 148a and 148b. Each prong 148 includes one or more air jets 150. The air jets 150 open into an atomizing or diffusing region 152 that is just forward of the powder tube end 106b. The number of air jets and the angle that their direct air at the powder flow is a matter of design choice to optimize atomization of the powder and to shape the spray pattern as desired. Typically, the more air that is directed at the powder flow will tend to atomize the flow more and enlarge the spray pattern.

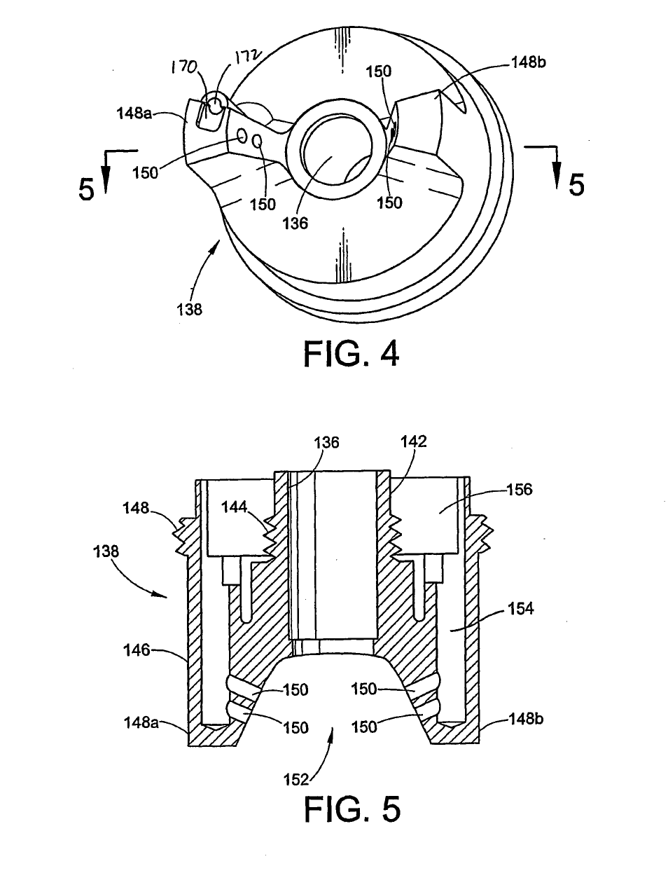

The air jets 150 open to an annular air passage 154. The annular air passage 154 further communicates with an annular cavity 156. The annular cavity 156 receives a female threaded air diffuser ring 158 (FIG. 6). The ring 158 is threaded into the air cap 138 with the internal threads 144. As best illustrated in FIG. 3A, the ring 158 includes a plurality if air holes 161 that provide an even air flow within the air cap 138. The ring 158 is also made of a electrically conductive material. For example, the ring 158 may be formed from carbon filled Teflon™. The ring 158 is made conductive because in addition to providing a diffused flow of air through the air cap 138, the ring 158 also electrically connects an electrode assembly 160 to a high voltage multiplier 162.

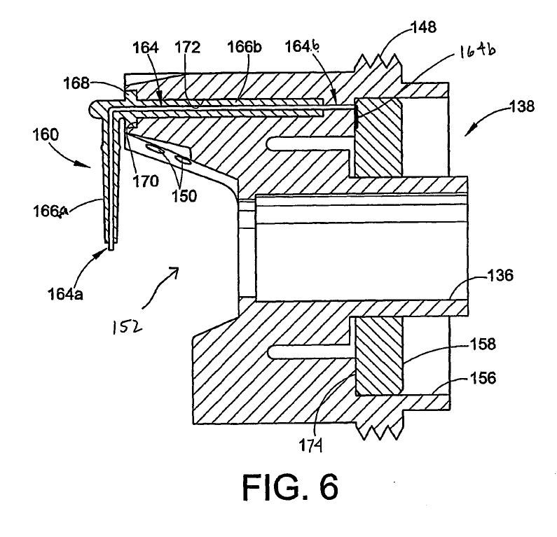

With reference to FIGS. 7A-C and FIG. 6, in accordance with another aspect of the invention an external electrode is provided just downstream from where the powder exits the powder feed tube end 106b. By placing the electrode on the outside of the gun housing 100, it does not interfere with the powder flow or with the cleanability of the powder tube. This is particularly useful with dense phase material flow.

In one embodiment, an electrode assembly 160 is provided that includes an electrode conductor 164 and an electrode holder 166. Preferably although not necessarily the holder 166 is molded over the conductor 164. A short portion 164a of the conductor extends out of the holder 166 and a longer portion 164b extends from the opposite end of the holder 166. The holder 166 is formed with an alignment key 168 in the form of a U-shaped boss that is received in a conforming recess 170 formed in the air cap 138 (see FIGS. 4 and 6). In this manner, the electrode holder 166 can only be installed with one orientation, so that the electrode tip 164a is optimally positioned downstream from the powder tube end 106b. The holder has an extended portion 166b that is inserted into a bore 172 in the air cap 138. A forward portion 166a of the holder 166 positions the electrode tip and is formed at about a right angle to the extended portion 166b.

As best illustrated in FIGS. 4 and 6, the inner portion 164b of the electrode is bent down and is captured between the conductive ring 158 and a shoulder 174 in the air cap. In this way, a solid electrical connection is made between the electrode conductor 164 and the conductive ring 158.

With reference to FIGS. 2A and 2B, a contact pin 180 is positioned in the front section 100a for intimate contact with a back side of the conductive ring 158. The contact pin 180 is also in contact with a resistor cable 182 which extends back through a forward portion of the middle housing section 100b. The resistor cable 182 may be any conventional resistive assembly that uses resistive carbon fiber and that provides current limiting protection for the electrostatic gun. This protection is enhanced by placing the resistance closer to the electrode. The resistor cable 182 may be supported in the housing with a guide member 184 and is supported at a back end thereof with a bias spring 186. The spring 186 maintains good electrical contact between the pin 180 and the electrical cable 188. The back end of the spring 186 makes electrical contact with a contact of an electrical cable 188. The electrical cable may be in accordance, for example, with U.S. Pat. Nos. 4,576,827 and 4,739,935 issued to the assignee of the present invention, the entire disclosures of which are fully incorporated herein by reference.

The electrical cable 188 extends back through the extended housing mid-section 100bThe electrical cable 188 at its back end makes electrical contact with an output contact 190 of the multiplier 162. A nut 192 may be used to secure the electrical cable 188 to the multiplier output 190.

Thus, in accordance with another aspect of the invention, the high voltage multiplier 162 is positioned in a rearward section of the gun housing, preferably near where the gun is mounted. In this manner the major weight of the gun is supported at the back end to significantly reduce the vibration and movement of the forward portion of the gun. If the multiplier were positioned closer to the front of the gun, as in conventional powder guns, the cantilever mounting could cause large bending moments. Thus, the invention contemplates an arrangement of a multiplier in line with an electrical cable coupled to a resistance and the electrode, with the multiplier in a rearward portion of the gun and the resistance positioned near the front of the gun.

The multiplier 162 is mounted to a bracket member 194 by a bolt 196. The bracket is thermally conductive, such as made of aluminum that is also mounted to the heat sink 120 by a pair of screws 198. In this manner the multiplier can be cooled by the heat sink 120. A conventional electrical input connector 121 is used to provide the input drive voltage, typically a low DC voltage, to the multiplier input as is known.

An air tube 200 is pushed onto a nipple 202 formed in the front housing section 100a. The nipple 202 forms an air passage to a main air passage 204 that opens to the annular cavity 156 just behind the conductive ring 158. Air that flows down the air tube 200 thus passes through the holes 161 in the ring 158 and then out the air jets 150 in the air cap 138 as described herein above.

The air tube 200 extends back through the gun housing 100 to a male connector 206. The male connector 206 mates with a first bore 208 that is formed in the front face 210 of the heat sink 120 (see FIG. 2C). The first bore 208 opens to a second bore 212 that is formed in the back face 214 of the heat sink 120. It will be noted from FIG. 2C that the centerline axis of the first bore 208 is offset from the centerline axis of the second bore 212 even though they are in fluid communication. This causes air turbulence and better cooling of the heat sink 120. A second fitting 216 is connected to the second bore 212 and serves as a connection for a main air hose (not shown). By this arrangement, air is thus provided to the air cap at the front of the gun, and the multiplier is cooled by the heat sink that is exposed to the same flow of air that goes to the air cap.

The exploded views of FIGS. 3A and 3B are provided to better illustrate the assembly described herein above.

In accordance with another aspect of the invention, as best illustrated in FIGS. 3A and 3B, the housing 100 sections are preferably formed with a tapered upper portion 220 formed by two rather steep walls 222 that join at a small radius apex 224. Preferably the apex is the top of the gun housing when the gun is being used for spraying material, so that the profile of the gun housing 100 reduces the amount of powder overspray that can alight on the gun and the steep sides can help shed powder.

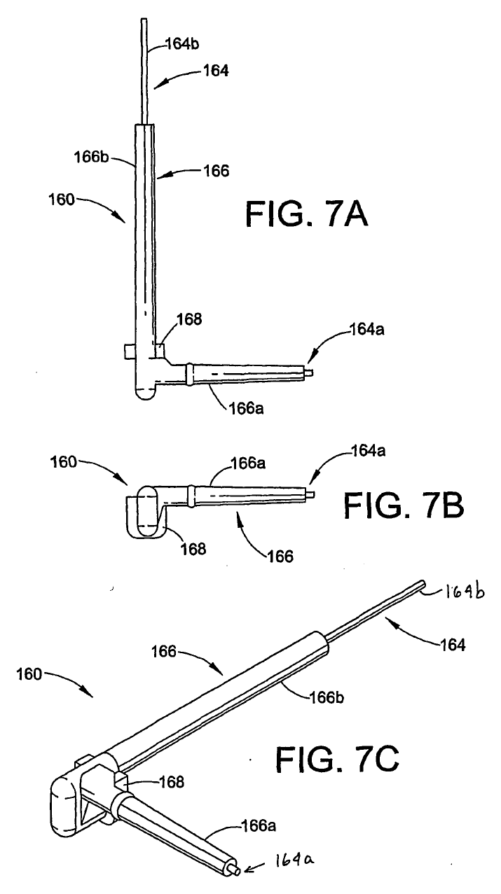

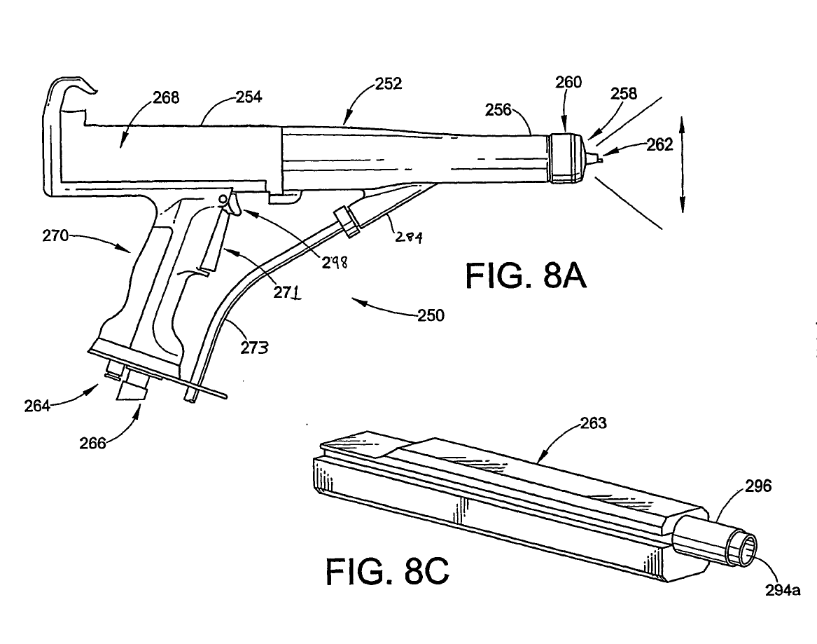

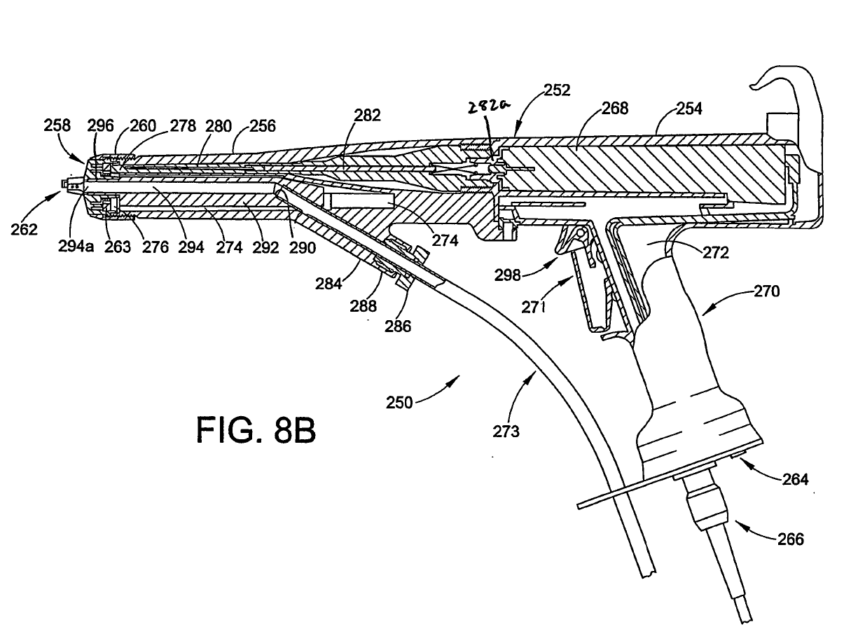

With reference to FIGS. 8A and 8B, the present invention also contemplates a manual spray applicator 250 that is particularly but not exclusively suited for dense phase material application. Many features of the manual version are the same as the automatic spray applicator described herein above.

The manual gun 250 includes a housing 252 that in this embodiment is a two piece housing including a rear or multiplier section 254 and a front or powder tube section 256 in the form of a barrel. These sections can be releasably secured together by any convenient mechanism such as a set screw for example. There is an air cap 258 that is retained on the outlet end of the front housing 256 by a retainer nut 260. The air cap holds an electrode assembly 262 and also a conductive diffuser ring 263 (shown in FIG. 8B). The air cap includes air jets 259. The air cap 258, retainer nut 260, electrode assembly 262 (including an electrode conductor and over-molded electrode holder) and conductive diffuser ring 263 may be the same design and operation as the corresponding parts in the automatic gun version described herein above.

The manual gun 250 further includes an air inlet, such as a fitting 264 that is connectable to an air line (not shown). An electrical connector 266 is provided for connection with an external low voltage power supply to operate the internal high voltage multiplier 268 (shown in dotted line in FIG. 8). The multiplier 268 is disposed in the rear housing section 254 above the grip handle 270 to reduce operator fatigue. The powder tube housing may be provided in any length as needed, or alternatively can be connectable to an extension housing if so desired for additional length of the spray applicator 250.

Operation of the manual gun 250 is similar to the automatic version except that the manual gun is manually triggered by an operator. Thus the manual gun includes a control trigger device 271. When this trigger 271 is depressed it causes electrical power to be delivered to the multiplier when electrostatic operation is to be used. Actuation of the control trigger 271 also allows air to flow to the air cap 258 via passages that extend through the handle 270 and the housing 252. Air may also be used to cool the multiplier via a heat sink as in the automatic version. The control trigger 271 actuation also causes powder to flow through the gun from a powder feed hose 273 and out the front end of the gun.

Air enters the applicator 250 via the air fitting 264 and into a passage 272 in the handle 270. This air can be used to help cool the multiplier 268. The passage 272 is in fluid communication with an air passage 274 in the front housing section 256. The passage 274 extends through the front housing section and opens to a recess 276 in the air cap 258 that receives the diffuser ring 263.

The electrode 262 makes electrical contact with the diffuser ring 263 in a manner as described herein above. There is also a contact pin 278 that contacts the ring 263. The contact pin 278 is part of an electrical circuit that includes a spring electrode 280 and a resistor assembly 282 and a conductive electrode spacer 282a that is electrically coupled to an output of the multiplier 268. The electrode spacer 282a may for example be made of a conductive Teflon™ material. This electrical circuit may be similar as described herein above in the embodiment of the automatic gun.

The powder feed hose 273 is inserted into a tubular extension 284 of the front housing section 256. A female threaded tube lock knob 286 and a lock ring 288 may be used to retain the feed hose 273 in the tubular extension 284. The lock ring and lock knob may be designed to function in a manner similar to the corresponding parts in the automatic gun described herein before.

The forward end 273a of the feed hose 273 inserts into a hose passageway 290 formed in a powder tube 292. The passageway 290 opens to a powder passage 294 that preferably lies along the central longitudinal axis of the applicator 250. The distal end 294a of the passageway 294 is formed by a tubular portion 296 of the powder tube 292 (see also FIG. 8C). The powder tube 292 is slip fit or otherwise slideably installed into the front housing section 256 with the passageway 290 aligning with the tubular extension 284 so that the powder feed hose 273 can easily be inserted into the powder tube 292. Note that the distal end 294a is received in the air cap 258 in a manner similar to the feed tube 106 and the air cap 138 in the automatic gun embodiment described herein above. The powder tube 292 thus forms a small diameter passageway for powder flow to the front of the gun, so that the manual gun 250 is well suited, for example, for dense phase powder flow.

The powder tube 292 thus provides an easily removable unit that forms the entire powder flow path for the spray gun 250. This makes the manual gun easy to clean for color change.

In accordance with another aspect of the invention, an adjusting member or control device in the form of a second trigger device 298 is provided. This trigger 298 may be actuated alone or in combination with the control trigger 271. The second trigger 298 is a pattern adjust trigger by which an operator can adjust the flow of air to the air cap 258. By increasing the air flow, the spray pattern is made larger and vice-versa As shown in FIG. 1, the control system 34 receives a signal from the pattern adjust trigger 298 (such as, for example, a change in impedance when the contacts close) and in response thereto issues a gun air control signal 299 The air control signal 299 can be used to control an air valve (not shown) disposed either inside the gun 250 or preferably in a pneumatic control section of the overall powder application system 10 to increase or decrease air flow to the air cap jets 259 as required.

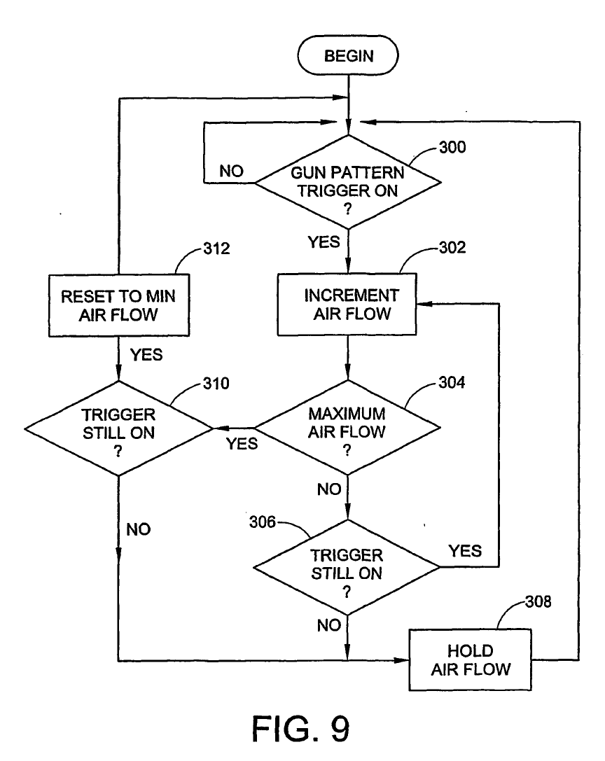

With reference to FIG. 9, an exemplary flow diagram is provided for a pattern adjust logic routine or algorithm. At step 300 the logic determines if the gun pattern adjust trigger 298 is activated (a de-bounce subroutine may optionally be included to prevent air adjustment unless the trigger has been activated for a minimum time period.) If it is not, the program waits until a valid trigger signal is received. When the trigger 298 is activated, at step 302 the air flow is incrementally increased. The amount of the incremental increase is a matter of design choice, wherein the operator can be provided with fine adjustment, course adjustment or both. At step 304 the program determines whether maximum air flow is being provided to the spray applicator 250. If it is not, then at step 306 the program checks if the trigger 298 is still on. If it is, the logic loops back to 302 to increment the air flow again. In this manner, the operator can hold the trigger 298 down and watch the pattern change with the increasing air flow, and stop by releasing the trigger 298

At step 306 if the trigger 298 is not still on then the program holds that air flow rate at 308 and loops back to wait for the next trigger actuation at step 300.

If at step 304 the system determines that the maximum air flow is being provided, then at step 310 the logic checks if the trigger 298 is still activated. If it is not the program branches to step 308 and holds the air flow rate (and hence the selected pattern). If at step 310 the trigger is still on, then the program resets the air flow back to the minimum air flow rate at 312 and loops back to step 300. Alternatively, at step 312 instead of resetting to the minimum flow rate and waiting for another trigger, the program could branch to step 302 and start incrementing again. This alternative method would allow the operator to keep the trigger depressed and observe the spray pattern as the air flow was adjusted through the maximum air flow rate and them incremented again from the minimum air flow rate.

As another alternative to the “ramp” feature that is described previously for the pattern shaping air, the control function may be programmed to incorporate a “hi/lo” feature. This “hi/lo” feature would use discrete actuation of the trigger 298 to switch between a “high” and a “low” pattern shaping air flow setting. During normal spraying, say the operator is using the high setting, which he controls from the manual gun controller, to give a large fan pattern. He then comes to an area where he needs a narrow fan pattern to better coat the part. He can actuate trigger 298 once, and the controller will change the flow of pattern shaping air to a lower setting, which the operator has previously set to a certain value through the manual gun controller. A second actuation of trigger 298 will revert the pattern shaping air flow back to the “high” setting.

It should be noted that varying the spray pattern by adjusting the air flow can also be implemented in the automatic spray applicator described herein above because the adjustment is essentially a software logic control function. In the automatic gun version the control system could be provided with a switch for the operator to activate to increment the air flow rate to the gun.

The invention has been described with reference to the preferred embodiment. Modifications and alterations will occur to others upon a reading and understanding of this specification and drawings. The invention is intended to include all such modifications and alterations insofar as they come within the scope of the appended claims or the equivalents thereof.

We claim:

1. A material application device for dense phase particulate material, comprising:
a housing having at a back end thereof a material inlet adapted to receive dense phase particulate material from a material feed hose;
a feed tube that extends from said material inlet through said housing to an outlet end of said housing;
and an air cap at said outlet end, said air cap receiving pressurized air from an air source and directing a flow of air at dense phase particulate material that exits said feed tube.

2. The device of claim 1 wherein said material comprises powder coating material.

3. The device of claim I wherein said flow of air from said air cap diffuses and atomizes said dense phase particulate material.

4. The device of claim 1 comprising an electrode disposed outside said housing to electrostatically charge said dense phase material that exits said feed tube.

5. The device of claim 4 wherein said electrode is supported in an electrode holder that is mounted on said air cap.

6. The device of claim 5 wherein said electrode holder is keyed to said air cap for fixed alignment of an electrode tip with said outlet end.

7. A material application device, comprising:
a housing having an inlet end and an outlet end;
said housing having a rearward portion with a material inlet, a mid-portion and a forward portion with a material outlet, wherein said mid-portion is substantially elongated compared to said rearward portion, said rearward portion having a support device; and
a voltage multiplier disposed in said rearward portion near where said support device.

8. The device of claim 7 wherein said support device comprises a grip for a manual gun.

9. The device of claim 7 wherein said support device mounts the material application device to a support.

10. The device of claim 9 wherein said support comprises a gun mover.

11. The device of claim 7 comprising a charging electrode disposed near said material outlet, an electrical cable that extends from an outlet of said multiplier through said elongated mid-portion to a resistive device, said resistive device being electrically coupled to said cable and said electrode at said forward portion of said housing.

12. The device of claim 7 wherein said housing is formed in three separate sections held together by a feed tube that extends from said inlet end to said outlet end.

13. The device of claim 7 wherein said housing has a profile that in end view has a narrower rounded upper portion with steeper sides compared to a lower portion to shed material that would otherwise fall onto said housing.

14. In a material application device of the type having a charging electrode and a supply of pressurized air that flows through a housing of the material application device, the improvement comprising:
a diffuser ring that diffuses flow of air through said housing, said diffuser ring being electrically conductive and electrically coupled to said electrode when the material application device is assembled.

15. In a material application device of the type comprising a housing having an outlet end through which material exits, one or more air orifices for directing air at material exiting said outlet end, and a trigger for controlling flow of material through said device, the improvement comprising:
a control device that can be actuated with or separate from the trigger, and
air control logic that detects actuation of said control device and adjusts flow of air through the air jets as a function of an actuation parameter of said control device.

16. A material application device for particulate material, comprising:
a housing having at a back end thereof a material inlet adapted to receive particulate material from a material feed hose;
a feed tube that extends from said material inlet through said housing to an outlet end of said housing, said feed tube having a first end located at said material inlet and a second end located at said outlet end;
and an air cap having an internal diameter, said second end of said feed tube being received within said internal diameter, said air cap receiving pressurized air from an air source and directing a flow of air at particulate material that exits said feed tube.

17. The device of claim 16 wherein said material comprises powder coating material.

18. The device of claim 16 wherein said flow of air from said air cap diffuses said particulate material.

19. The device of claim 16 comprising an electrode disposed outside said housing to electrostatically charge material that exits the material application device.

20. The device of claim 19 wherein said electrode is supported in an electrode holder that is mounted on said air cap.

21. The device of claim 20 wherein said electrode holder is keyed to said air cap for fixed alignment of an electrode tip with said outlet end.

22. A powder coating material spray gun having a barrel containing a powder path which the powder coating material flows through as it passes from a powder coating material supply hose, which is connected to the gun, through the gun, at least a part of the powder path being removably secured inside the barrel.

23. The spray gun of claim 22 wherein said removable part of the powder path is removable without the need for tools.

24. The spray gun of claim 22 wherein said removal part of the powder path is slideably received within the gun.

25. A powder coating material spray gun having a barrel containing a powder path which the powder coating material flows through as it passes from a powder coating material supply hose through the gun and out the spray nozzle of the gun, the barrel also having an air flow passage which supplies compressed air to an air cap which is secured to the front of the gun around the powder spray nozzle, the air cap having one or more openings through which the compressed air passes to impact the powder material being sprayed from the gun and shape the powder spray pattern being sprayed from the gun, further comprising an adjusting member which controls the flow of the compressed air through the air cap to adjust the shape of the powder spray pattern.

26. The spray gun of claim 25 wherein the spray gun is a handheld, manual spray gun and the adjusting member is provided on the spray gun.

27. The spray gun of claim 26 wherein the adjusting member is a trigger member provided on the gun.

28. The spray gun of claim 26 further comprising a controller which repeatedly increases and decreases the flow of compressed air through the air cap to permit the operator to set an optimal spray pattern.

29. The spray gun of claim 28 wherein the spray gun is a handheld, manual spray gun and a trigger member is provided on the spray gun to select the air flow setting which provides the desired spray pattern while the controller is repeatedly increasing and decreasing the flow of compressed air through the air cap.

30. A powder coating material spray gun having a barrel containing a powder path which the powder coating material flows through as it passes from a powder coating material supply hose through the gun and out the spray nozzle of the gun, the barrel also having a passage through which an electric supply line passes to connect to an electrode which is provided adjacent the spray nozzle of the gun to electrostatically charge powder material which is sprayed from the gun, the electrode enclosed within a molded assembly.

31. The powder spray gun of claim 30 wherein the barrel also has an air flow passage which supplies compressed air to an air cap which is secured to the front of the gun around the powder spray nozzle, the air cap having one or more openings through which the compressed air passes to impact the powder coating material being sprayed from the gun and shape the powder spray pattern being sprayed from the gun, the molded electrode assembly being received within the air cap.
